(19) United States
(12) Patent Application Publication
(10) Pub. No.: US 2026/0175748 A1
(43) Pub. Date: Jun. 25, 2026

(54) RECLINING DEVICE AND VEHICLE SEAT

(71) Applicants: NHK SPRING CO., LTD., Yokohama-shi (JP); SUBARU CORPORATION, Tokyo (JP)

(72) Inventors: Hiroshi YAGAME, Yokohama-shi (JP); Yuhei TSUKUTA, Yokohama-shi (JP); Masaya SHODA, Yokohama-shi (JP); Noriyuki FUKUCHI, Yokohama-shi (JP); Fumito KITANAKA, Tokyo (JP); Masato FUKUSHIMA, Tokyo (JP); Ayaka KASHIWAGI, Tokyo (JP)

(21) Appl. No.: 19/422,171

(22) Filed: Dec. 16, 2025

(30) Foreign Application Priority Data
Dec. 20, 2024 (JP) 2024-225725

(51) Int. Cl. B60N 2/20; B60N 2/90

(52) U.S. Cl. CPC B60N 2/20; B60N 2/90

(57) ABSTRACT

In a reclining device, a lock mechanism locks tilting of a seat back. A knob is connected to a catch plate, and in a case in which the knob is operated, the catch plate is rotated, and a lock mechanism unlocks tilting of the seat back. At a time of a side collision of a vehicle, an impact load is input to a cap of the knob, the knob is disconnected from the catch plate, and a bracket restricts rotation of the catch plate. Therefore, even in a case in which the knob is operated by an impact load, the rotation of the catch plate can be restricted, and the unlocking of the tilting of the seat back can be restricted.

### CROSS-REFERENCE TO RELATED APPLICATION

This application is based on and claims priority under 35 USC 119 from Japanese Patent Application No. 2024-225725 filed on Dec. 20, 2024, the disclosure of which is incorporated by reference herein.

### BACKGROUND

### Technical Field

The present invention relates to a reclining device in which a lock mechanism locks tilting of a seat back, and a vehicle seat provided with the reclining device.

### Related Art

In a seat described in Japanese Patent Application Laid-Open (JP-A) No. 2000-108738, tilting of a seat back is locked, and a reclining lever is operated to unlock the tilting of the seat back.

In this seat, at the time of side collision of a vehicle, the operation of the reclining lever due to input of an impact load to the reclining lever is suppressed by a bracket for preventing upward shift of the lever, and unlocking of the tilting of the seat back is suppressed.

### SUMMARY

In view of the above fact, an object of the invention is to provide a reclining device and a vehicle seat which can regulate unlocking of tilting of a seat back at the time of side collision of a vehicle.

A reclining device of a first aspect of the invention includes: a lock mechanism locking tilting of a seat back in a vehicle seat; a connecting member connected to the lock mechanism, the connecting member being rotated so that the lock mechanism unlocks tilting of the seat back; an operation member connected to the connecting member, the operation member being operated to rotate the connecting member and being disconnected from the connecting member by receiving an impact load at a time of a side collision of a vehicle; and a restriction member restricting rotation of the connecting member in a case in which the operation member is disconnected from the connecting member.

In the reclining device of the first aspect of the invention, the lock mechanism locks tilting of the seat back in the vehicle seat. The connecting member is connected to the lock mechanism, the operation member is connected to the connecting member, and the operation member is operated to rotate the connecting member, so that the lock mechanism unlocks tilting of the seat back.

At the time of a side collision of the vehicle, an impact load is input to the operation member, the operation member is disconnected from the connecting member, and the restriction member restricts rotation of the connecting member. Therefore, even in a case in which the operation member is operated by an impact load, the rotation of the connecting member can be restricted, and the unlocking of the tilting of the seat back can be restricted.

In a reclining device of a second aspect of the invention in the reclining device of the first aspect of the invention, after the operation member is disconnected from the connecting member and the restriction member restricts rotation of the connecting member, the operation member is operated so that the operation member is connected to the connecting member and the restriction member releases the restriction on the rotation of the connecting member.

In the reclining device of the second aspect of the invention, after the operation member is disconnected from the connecting member and the restriction member restricts rotation of the connecting member, the operation member is operated so that the operation member is connected to the connecting member and the restriction member releases the restriction on the rotation of the connecting member. Therefore, in a case in which the operation member is further operated, the connecting member can be rotated, and the tilting of the seat back can be unlocked.

In a reclining device of a third aspect of the invention in the reclining device of the second aspect of the invention, after the operation member is disconnected from the connecting member and the restriction member restricts rotation of the connecting member, the operation member is operated to move the connecting member, so that the operation member is connected to the connecting member and the restriction member releases the restriction on the rotation of the connecting member.

In the reclining device of the third aspect of the invention, after the operation member is disconnected from the connecting member and the restriction member restricts rotation of the connecting member, the operation member is operated to move the connecting member, so that the operation member is connected to the connecting member and the restriction member releases the restriction on the rotation of the connecting member. Therefore, with a simple configuration, the operation member can be connected to the connecting member, and the restriction member can release the restriction on the rotation of the connecting member.

In a reclining device of a fourth aspect of the invention in the reclining device of the second aspect or the third aspect of the invention, an operation amount of the operation member for causing the operation member to be connected to the connecting member and for causing the restriction member to release the restriction on the rotation of the connecting member is equal to or larger than an operation amount of the operation member for causing the lock mechanism to unlock tilting of the seat back.

In the reclining device of the fourth aspect of the invention, the operation amount of the operation member for causing the operation member to be connected to the connecting member and for causing the restriction member to release the restriction on the rotation of the connecting member is equal to or larger than the operation amount of the operation member for causing the lock mechanism to unlock tilting of the seat back. Therefore, it is possible to suppress that the operation member is unnecessarily connected to the connecting member and the restriction member releases the restriction on the rotation of the connecting member.

A vehicle seat of a fifth aspect of the invention includes: a seat cushion; a seat back; and the reclining device of any one of the first to fourth aspects provided between the seat cushion and the seat back.

In the vehicle seat of the fifth aspect of the invention, the reclining device of any one of the first to fourth aspects of the invention is provided between the seat cushion and the seat back. Therefore, the same effects as those of any one of the first to fourth aspects of the invention can be obtained.

### BRIEF DESCRIPTION OF THE DRAWINGS

Exemplary embodiments of the present invention will be described in detail based on the following figures, wherein:

FIG. 1 is an exploded perspective view illustrating a vehicle seat according to a first embodiment of the invention as viewed from a diagonally front left side;

FIG. 2 is a side view illustrating the vehicle seat according to the first embodiment of the invention as viewed from a left side;

FIG. 3 is a side view illustrating a main part of the vehicle seat according to the first embodiment of the invention as viewed from a left side;

FIG. 4A is a cross-sectional view (a cross-sectional view taken along line 4-4 in FIG. 2) of the vehicle seat according to the first embodiment of the invention as viewed from a front side;

FIG. 4B is an enlarged view of a region 4B in FIG. 4A;

FIG. 5 is an exploded perspective view illustrating a vehicle seat according to a second embodiment of the invention as viewed from a diagonally front left side;

FIG. 6 is a side view illustrating the vehicle seat according to the second embodiment of the invention as viewed from a left side;

FIG. 7 is a side view illustrating a main part of the vehicle seat according to the second embodiment of the invention as viewed from a left side;

FIG. 8 is a cross-sectional view (a cross-sectional view taken along line 8-8 in FIG. 6) of the vehicle seat according to the second embodiment of the invention as viewed from a front side;

FIG. 9A is a cross-sectional view (a cross-sectional view taken along line 9-9 in FIG. 6) of the vehicle seat according to the second embodiment of the invention as viewed from an upper side;

FIG. 9B is an enlarged view of a region 9B in FIG. 9A;

FIG. 10 is a perspective view illustrating a catch plate, a knob, and the like of the vehicle seat according to the second embodiment of the invention as viewed from a diagonally front right side;

FIG. 11A is a perspective view illustrating the knob and the like of the vehicle seat according to the second embodiment of the invention as viewed from a diagonally front right side;

FIG. 11B is a perspective view illustrating the knob and the like of the vehicle seat according to the second embodiment of the invention as viewed from a diagonally front left side;

FIG. 12A is a view illustrating a first operation time of the knob in the vehicle seat according to the second embodiment of the invention;

FIG. 12B is a view illustrating a second operation time of the knob in the vehicle seat according to the second embodiment of the invention;

FIG. 13A is a side view illustrating the catch plate, the knob, and the like of the vehicle seat according to the second embodiment of the invention as viewed from a right side;

FIG. 13B is a perspective view illustrating a state at the time of side collision of a vehicle in the vehicle seat according to the second embodiment of the invention as viewed from a diagonally front right side;

FIG. 14A is a perspective view illustrating a state at the time of side collision of a vehicle in the vehicle seat according to the second embodiment of the invention as viewed from a diagonally upper right side;

FIG. 14B is a perspective view illustrating the second operation time of the knob in the vehicle seat according to the second embodiment of the invention as viewed from a diagonally front right side;

FIG. 15A is a perspective view illustrating the catch plate, the knob, and the like of the vehicle seat according to the second embodiment of the invention as viewed from a right side;

FIG. 15B is a perspective view illustrating the catch plate, the knob, and the like of the vehicle seat according to the second embodiment of the invention as viewed from a front side;

FIG. 15C is a perspective view illustrating the catch plate, the knob, and the like of the vehicle seat according to the second embodiment of the invention as viewed from an upper side;

FIG. 16A is a perspective view illustrating an initial stage of the second operation of the knob in the vehicle seat according to the second embodiment of the invention as viewed from a right side;

FIG. 16B is a perspective view illustrating the initial stage of the second operation of the knob in the vehicle seat according to the second embodiment of the invention as viewed from a front side;

FIG. 16C is a perspective view illustrating the initial stage of the second operation of the knob in the vehicle seat according to the second embodiment of the invention as viewed from an upper side;

FIG. 17A is a perspective view illustrating an intermediate stage of the second operation of the knob in the vehicle seat according to the second embodiment of the invention as viewed from a right side;

FIG. 17B is a perspective view illustrating the intermediate stage of the second operation of the knob in the vehicle seat according to the second embodiment of the invention as viewed from a front side; and

FIG. 17C is a perspective view illustrating the intermediate stage of the second operation of the knob in the vehicle seat according to the second embodiment of the invention as viewed from an upper side.

### DETAILED DESCRIPTION

### First Embodiment

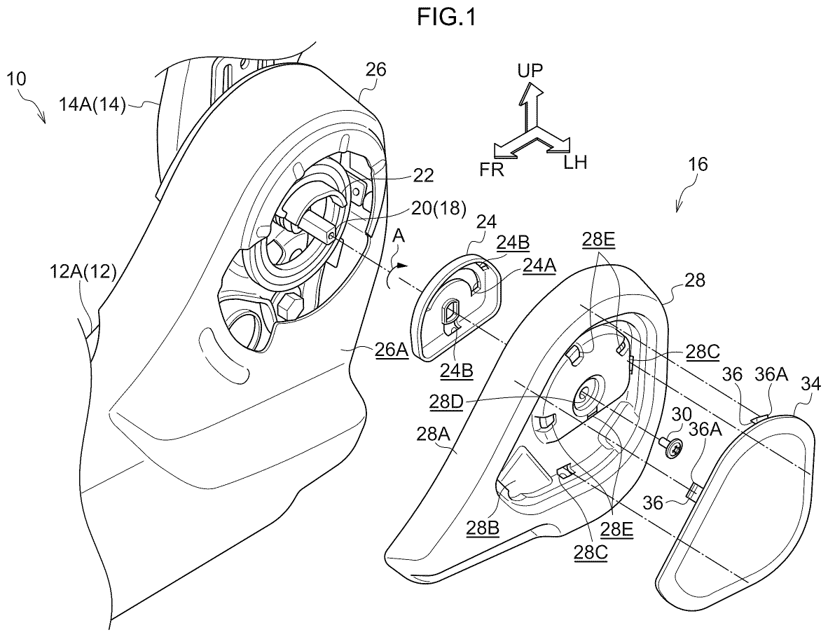

FIG. 1 is an exploded perspective view illustrating a vehicle seat 10 according to a first embodiment of the invention as viewed from a diagonally front left side. In the drawings, the front side of the vehicle seat 10 is indicated by an arrow FR, the left side (outside in a vehicle width direction) of the vehicle seat 10 is indicated by an arrow LH, and the upper side of the vehicle seat 10 is indicated by an arrow UP.

The vehicle seat 10 according to this embodiment is provided on the front side and the left side of a vehicle interior of a vehicle (automobile), and a B-pillar of the vehicle is disposed near the left side of a rear end portion of the vehicle seat 10. A seat cushion 12 is provided below the vehicle seat 10, and an occupant of the vehicle is seated on the seat cushion 12. A seat back 14 is provided on the upper side of a rear end portion of the seat cushion 12, and the seat back 14 supports the back of the occupant.

As illustrated in FIG. 1, a reclining device 16 is provided between a cushion hinge 12A of the seat cushion 12 and a back hinge 14A of the seat back 14.

A lock mechanism 18 is provided in the reclining device 16, and the lock mechanism 18 locks tilting of the seat back 14 (back hinge 14A). The lock mechanism 18 is provided with a shaft 20 made of a metal as a release portion, and the shaft 20 extends leftward and has a portion, which is formed in a substantially rectangular columnar shape, other than a proximal end portion (right end portion). The shaft 20 is made rotatable by a predetermined angle in a release direction A from an initial position, and the shaft 20 is made non-rotatable by exceeding a predetermined angle in the release direction A from the initial position.

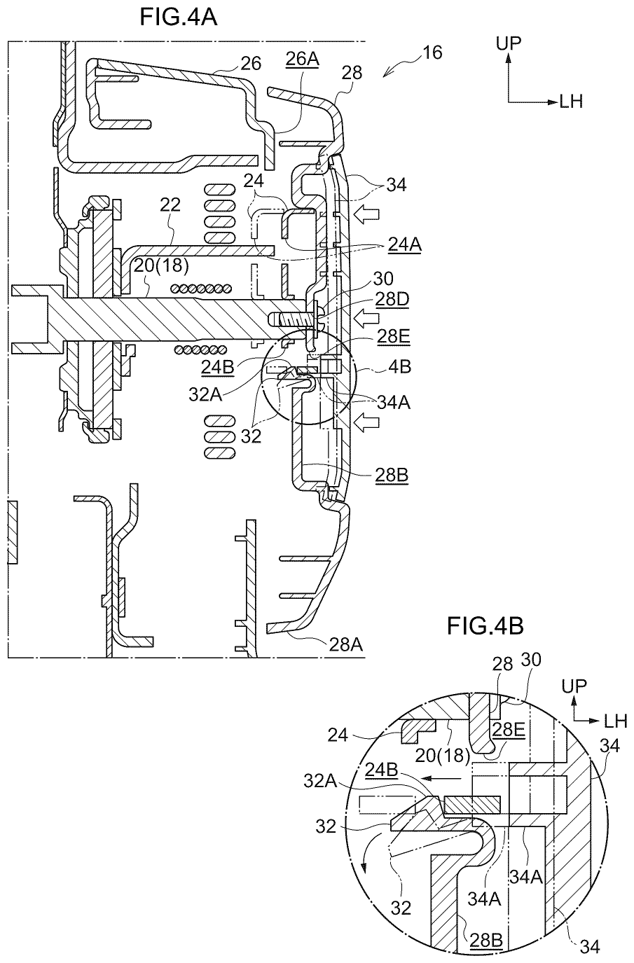

A bracket 22 (spring holding bracket, see FIG. 4A) having an L-shaped cross section plate shape and made of a metal as a restriction member is fixed around the shaft 20. A right wall of the bracket 22 is disposed perpendicular to a right-left direction, and the shaft 20 is rotatably passed through the right wall of the bracket 22. An upper wall (restriction portion) of the bracket 22 protrudes leftward, and the upper wall of the bracket 22 is curved in a convex shape upward in a front-rear direction.

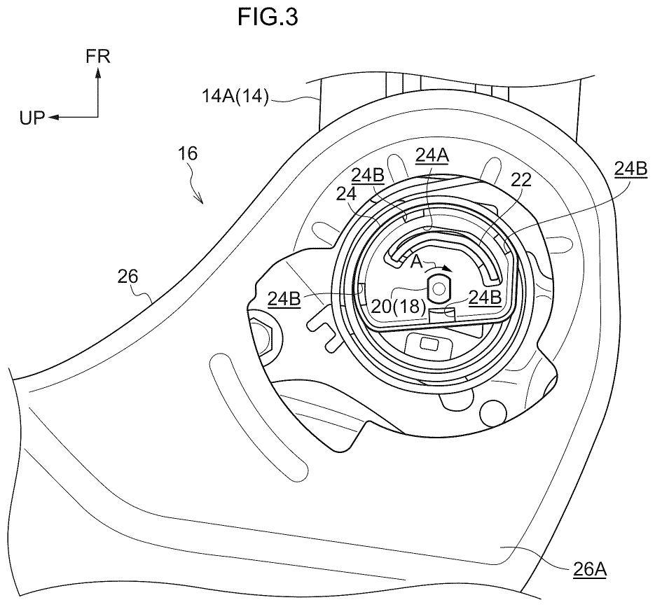

A catch plate 24 (see FIGS. 3 and 4A) having a substantially rectangular plate shape and made of a resin as a connecting member is disposed at a distal end portion (left end portion) of the shaft 20. A tubular peripheral wall is integrally provided on the entire circumference of the catch plate 24, and the peripheral wall of the catch plate 24 protrudes leftward. The shaft 20 passes through and is fitted to a lower portion of a bottom wall (right wall) of the catch plate 24, and the catch plate 24 is integrally rotatable with the shaft 20. A long restriction hole 24A as a restricted portion is formed to penetrate through an upper portion of the bottom wall of the catch plate 24, and the restriction hole 24A is curved in a convex shape in a longitudinal direction to the upper side and is opposed to the upper wall of the bracket 22 in the right-left direction. A connecting hole 24B having a substantially rectangular shape as a connected portion is formed to penetrate through an upper portion, a lower portion, a front portion, and a rear portion of the catch plate 24, and the connecting hole 24B is disposed from the peripheral wall to the bottom wall of the catch plate 24.

A cover 26 made of a resin as an arrangement member is provided on the left side of the lock mechanism 18, and the cover 26 covers a portion from a rear portion of the seat cushion 12 to a lower end portion of the seat back 14 from the left side. An arrangement recess 26A having a substantially trapezoidal shape in front view is formed in a rear portion of the cover 26, and the arrangement recess 26A is opened to the left side, the upper side, the front side, and the rear side. A part of the bottom wall (right wall) of the arrangement recess 26A is opened, the distal end portion of the shaft 20 and the catch plate 24 are disposed in the arrangement recess 26A, and the upper wall of the bracket 22 is exposed.

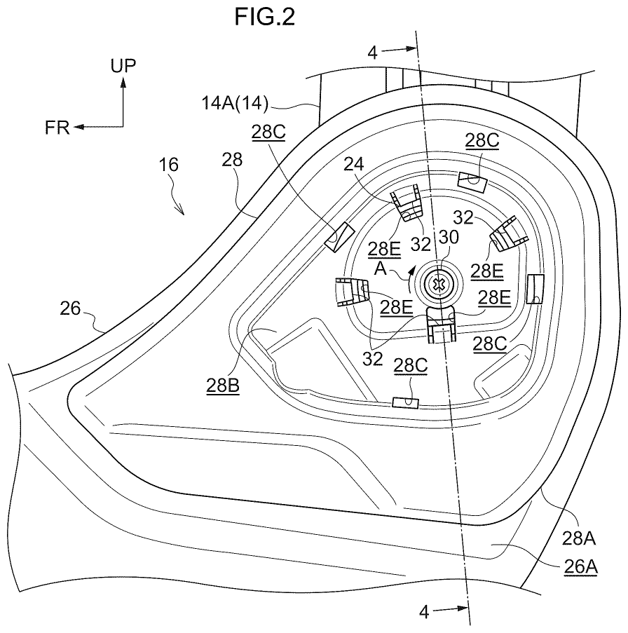

In the arrangement recess 26A, a knob 28 (see FIGS. 2, 4A, and 4B) having a substantially trapezoidal plate shape and made of a resin as a body member constituting an operation member is disposed, and a front portion of the knob 28 protrudes forward. A tubular peripheral wall 28A is integrally provided on the entire circumference of the knob 28, and the peripheral wall 28A protrudes rightward. A coupling recess 28B having a substantially trapezoidal shape in front view is formed in the knob 28, and the coupling recess 28B is opened to the left side. A rectangular coupling hole 28C as a coupled portion is formed to penetrate through an upper portion, a lower portion, a front portion, and a rear portion of a peripheral portion of the coupling recess 28B.

A circular support hole 28D is formed to penetrate through a central portion of a bottom wall (right wall) of the coupling recess 28B, and a leg portion of a screw 30 coaxially passes through and is fitted into the support hole 28D. The leg portion of the screw 30 is coaxially screwed to the distal end portion of the shaft 20, the bottom wall of the coupling recess 28B is sandwiched between the distal end portion of the shaft 20 and a head portion of the screw 30, and the knob 28 is made rotatable about the screw 30.

A rectangular insertion hole 28E is formed to penetrate through the bottom wall of the coupling recess 28B on an upper side, a lower side, a front side, and a rear side of the screw 30, and the insertion hole 28E faces a position where the connecting hole 24B is formed in the peripheral wall of the catch plate 24 in the right-left direction. A connecting claw 32 (see FIG. 4B) having a substantially J-shaped cross section plate as a connecting portion is integrally provided at an end portion of the insertion hole 28E on a side opposite to the screw 30, and the connecting claw 32 is disposed outside the peripheral wall of the catch plate 24. A proximal end side portion of the connecting claw 32 protrudes to the left side, and a distal end side portion of the connecting claw 32 extends to the right side. A connecting protrusion 32A having a substantially triangular prism shape is integrally provided at a distal end portion (right end portion) of the connecting claw 32, and the connecting protrusion 32A protrudes toward the screw 30 and has a left surface inclined in a direction toward the screw 30 as going rightward. The connecting claw 32 has the connecting protrusion 32A inserted into the connecting hole 24B by temporary elastic deformation, and the left surface of the connecting protrusion 32A is engaged with the left end of the connecting hole 24B from the right side. Therefore, the knob 28 is integrally rotatably connected to the catch plate 24, and the occupant operates the knob 28 to be rotated by a predetermined angle in the release direction A to rotate the catch plate 24 by a predetermined angle in the release direction A, so that the shaft 20 of the lock mechanism 18 is rotated by a predetermined angle in the release direction A, and the lock mechanism 18 unlocks the tilting of the seat back 14.

A cap 34 (see FIGS. 4A and 4B) having a substantially trapezoidal plate shape and made of a resin as a covering member constituting an operation member is fitted to the coupling recess 28B, and a left surface of the cap 34 is flush with a left surface of the knob 28. A coupling claw 36 having a substantially rectangular plate shape as a coupling portion is integrally provided at an upper portion, a lower portion, a front portion, and a rear portion of the peripheral portion of the cap 34, and the coupling claw 36 extends rightward. A coupling protrusion 36A having a triangular prism shape is integrally provided at a distal end portion (right end portion) of the coupling claw 36, and the coupling protrusion 36A protrudes to the outer peripheral side of the coupling recess 28B and has a left surface disposed perpendicular to the right-left direction. The coupling claw 36 is inserted into the coupling hole 28C on a peripheral portion of the coupling recess 28B by temporary elastic deformation, and the coupling protrusion 36A is locked from the right side to the periphery of the coupling hole 28C on the peripheral portion of the coupling recess 28B, so that the leftward movement of the coupling protrusion 36A is locked, and the leftward movement of the cap 34 is locked, whereby the cap 34 is integrally rotatably connected to the knob 28.

A boss 34A having a rectangular tubular shape as a release portion is integrally provided on a right surface of the cap 34 on the left side of each insertion hole 28E of the knob 28, and the boss 34A protrudes rightward. The boss 34A is opposed to the peripheral wall of the catch plate 24 in the right-left direction via the insertion hole 28E, and an outer wall (the side wall opposite to the screw 30) of the boss 34A is opposed to the distal end side portion of the connecting claw 32 of the knob 28 in the right-left direction via the insertion hole 28E.

Next, the operation of this embodiment will be described.

In the reclining device 16 of the vehicle seat 10 having the above configuration, the lock mechanism 18 locks the tilting of the seat back 14, and the catch plate 24 is integrally rotatably connected to the shaft 20 of the lock mechanism 18. A left surface of the connecting protrusion 32A of the connecting claw 32 of the knob 28 is engaged with a left end of the connecting hole 24B of the catch plate 24, and the knob 28 is integrally rotatably connected to the catch plate 24. In a case in which the knob 28 (including the cap 34) is operated to rotate by a predetermined angle in the release direction A, the catch plate 24 and the shaft 20 are rotated by a predetermined angle in the release direction A integrally with the knob 28, and the lock mechanism 18 unlocks the tilting of the seat back 14.

In a case in which an impact load from the B-pillar of the vehicle is input to the cap 34 at the time of side collision of the vehicle and the cap 34 is moved rightward (inward in the vehicle width direction), the boss 34A of the cap 34 is inserted into the insertion hole 28E of the knob 28 to press the peripheral wall of the catch plate 24 rightward, so that the catch plate 24 is moved rightward (see FIGS. 4A and 4B). In a case in which the left end of the connecting hole 24B presses the left surface of the connecting protrusion 32A rightward and the connecting claw 32 is moved to a side opposite to the screw 30, the connecting claw 32 (connecting protrusion 32A) is disengaged from the connecting hole 24B, and the knob 28 is disconnected from the catch plate 24. The upper wall of the bracket 22 is inserted into the restriction hole 24A of the catch plate 24, and the bracket 22 restricts the rotation of the catch plate 24. Thereby, even in a case in which the knob 28 is operated to rotate by an impact load, the rotation of the catch plate 24 can be restricted, so that the unlocking of the tilting of the seat back 14 can be suppressed and the unnecessary tilting of the seat back 14 can be suppressed.

In a case in which the cap 34 is moved to the right side by an impact load at the time of side collision of the vehicle, the outer wall of the boss 34A moves the distal end side portion of the connecting claw 32 to a side opposite to the screw 30 to assist the disengagement of the connecting claw 32 (connecting protrusion 32A) from the connecting hole 24B. Therefore, the connecting claw 32 can be appropriately disengaged from the connecting hole 24B, and the knob 28 can be appropriately disconnected from the catch plate 24.

### Second Embodiment

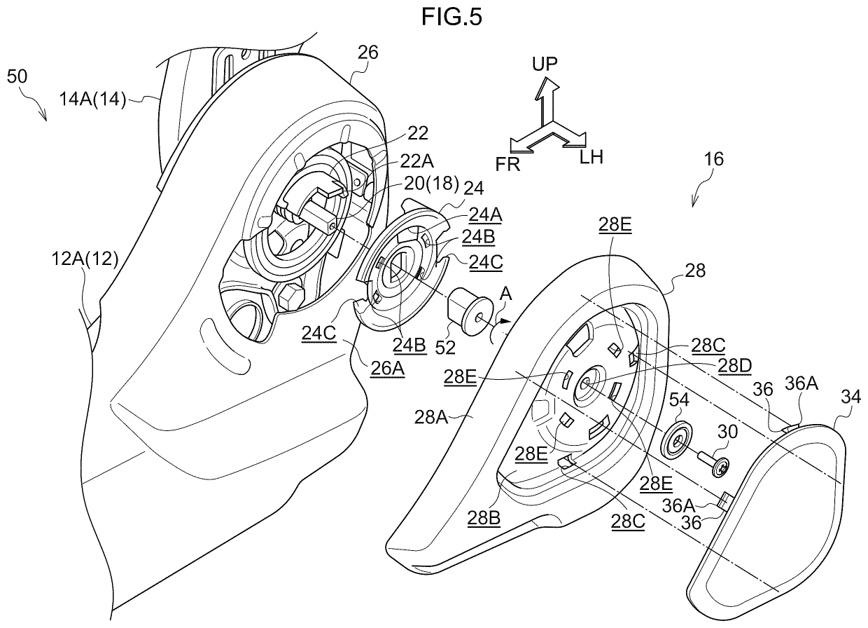

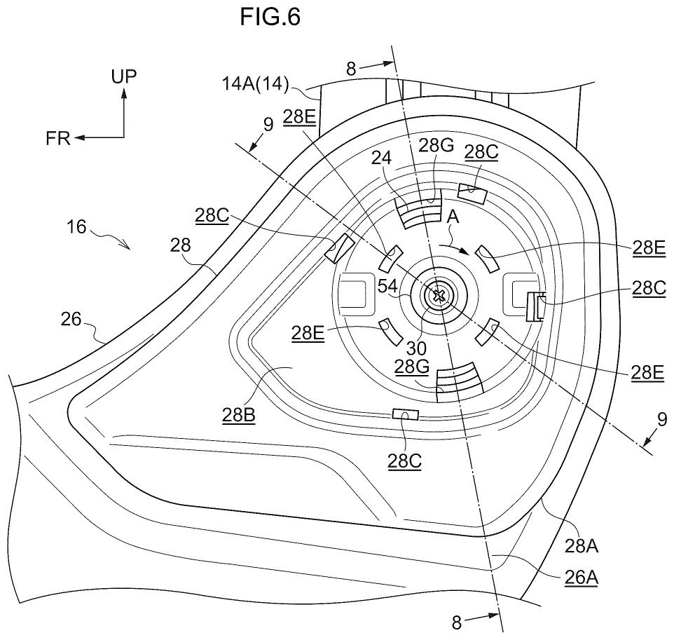

FIG. 5 is an exploded perspective view illustrating a vehicle seat 50 according to a second embodiment of the invention as viewed from a diagonally front left side.

The vehicle seat 50 according to this embodiment has substantially the same configuration as that of the first embodiment, but differs in the following points.

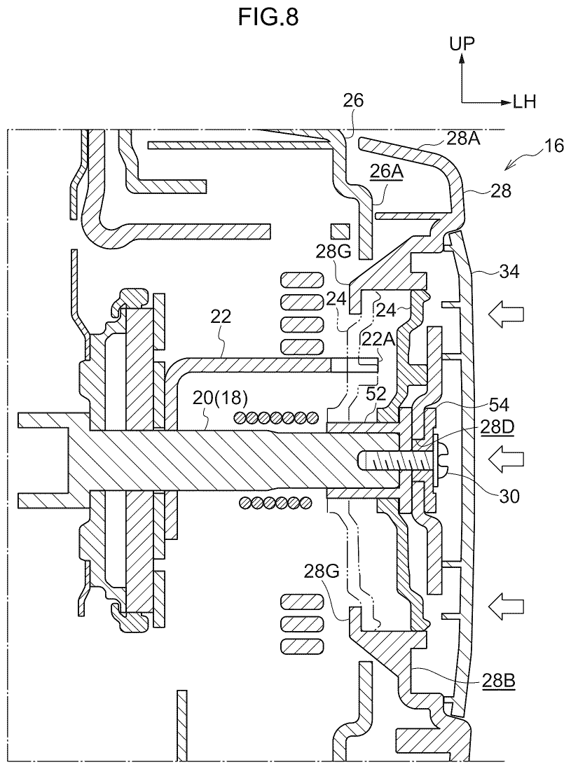

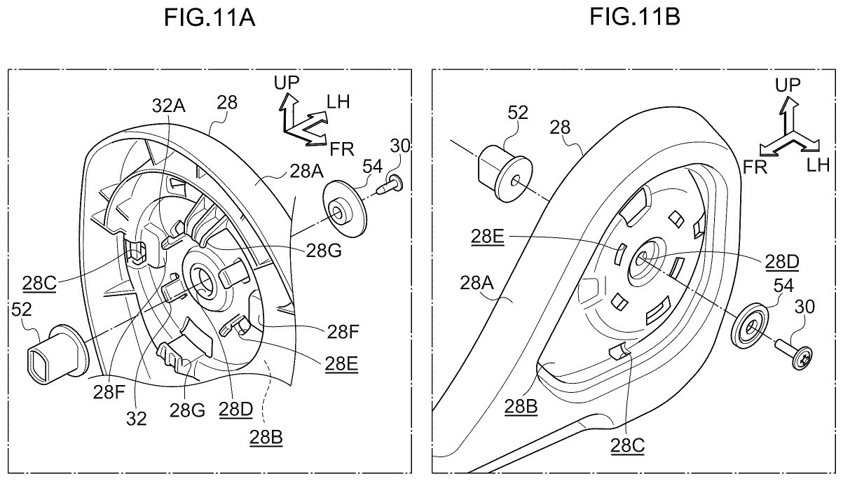

As illustrated in FIG. 5, in the reclining device 16 of the vehicle seat 50, a bush 52 (see FIGS. 8, 11A, and 11B) having a substantially bottomed rectangular tubular shape and made of a resin is disposed at the distal end portion of the shaft 20 of the lock mechanism 18, and the inside of the bush 52 is opened to the right side. The distal end portion of the shaft 20 is fitted into the bush 52, and the bush 52 is integrally rotatable with the shaft 20. A bottom wall (left end portion) of the bush 52 is coaxially enlarged with respect to the other portion of the bush 52, and the bottom wall of the bush 52 has a disk shape.

A restricting plate 22A having a rectangular plate shape as a restricting portion is integrally provided at a central portion in the front-rear direction of the upper wall of the bracket 22, and the restricting plate 22A protrudes leftward.

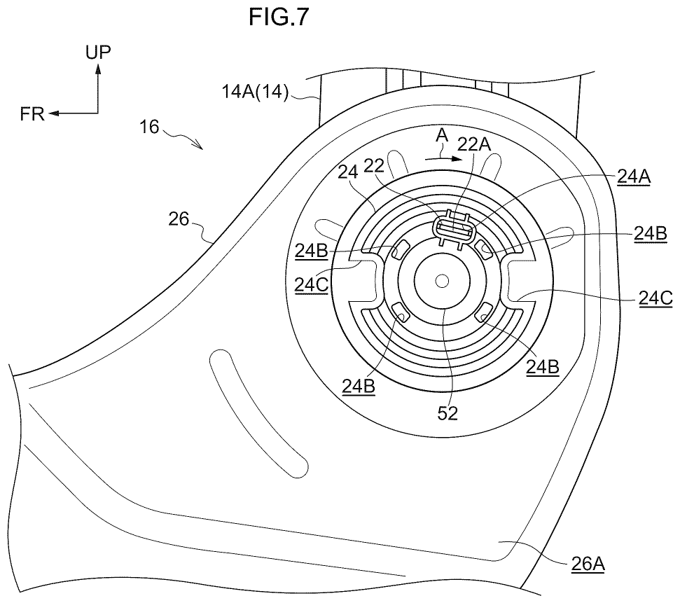

The catch plate 24 (see FIG. 7) has a substantially disk shape, and the restriction hole 24A having a substantially rectangular shape is formed to penetrate through the upper portion of the catch plate 24. The vicinity of the bottom wall of the bush 52 passes through and is fitted to a center portion of the catch plate 24, and the catch plate 24 is integrally rotatable with the shaft 20 and the bush 52. The catch plate 24 abuts on the bottom wall of the bush 52, thereby restricting leftward movement of the catch plate 24. A rectangular connecting notch 24C as a connected portion is formed to penetrate through a front end portion and a rear end portion of the catch plate 24, and the connecting notch 24C is opened radially outward of the catch plate 24. The connecting hole 24B is formed to penetrate through an upper portion and a lower portion of the front portion and an upper portion and a lower portion of the rear portion of the catch plate 24.

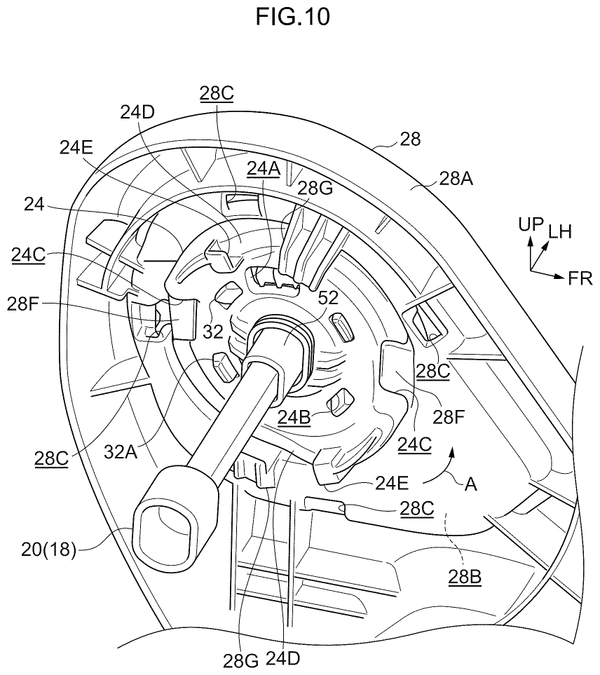

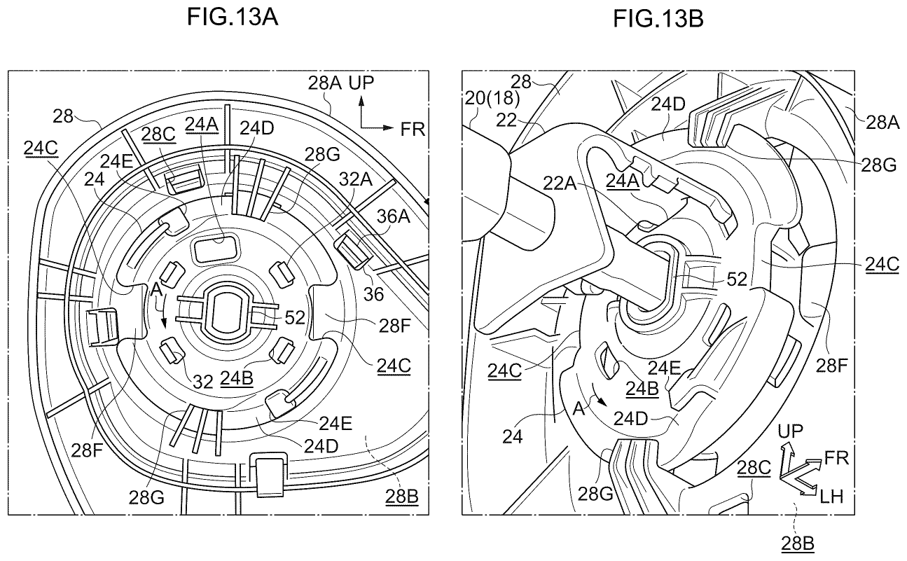

An inclined surface 24D (see FIGS. 10 and 13A) as a moved portion is formed in an upper portion and a lower portion of a peripheral portion of a right surface of the catch plate 24, and the inclined surface 24D is inclined in a direction toward the right side as it goes toward the release direction A. A rotation hook 24E having a substantially L-shaped cross section plate shape as a rotated portion is integrally provided at an end portion on the release direction A side of the inclined surface 24D, and a proximal end side portion of the rotation hook 24E protrudes to the right side. A distal end side portion of the rotation hook 24E protrudes to a side opposite to the release direction A, and the screw 30 side in the rotation hook 24E is closed.

A spacer 54 (see FIGS. 8, 11A, and 11B) having a substantially cylindrical shape and made of a resin is coaxially disposed on the left side of the support hole 28D of the bottom wall of the coupling recess 28B of the knob 28. A right side portion of the spacer 54 is fitted into the support hole 28D, and the diameter of the outer periphery of the spacer 54 is enlarged coaxially with the right side portion. The leg portion of the screw 30 coaxially passes through and is fitted in the spacer 54 and the bottom wall of the bush 52, and the leg portion of the screw 30 is coaxially screwed to the distal end portion of the shaft 20. Therefore, the spacer 54 and the bottom wall of the bush 52 are sandwiched between the distal end portion of the shaft 20 and the head portion of the screw 30, and the bottom wall of the coupling recess 28B is fitted between a left side portion of the spacer 54 and the bottom wall of the bush 52, so that the knob 28 is rotatable about the screw 30.

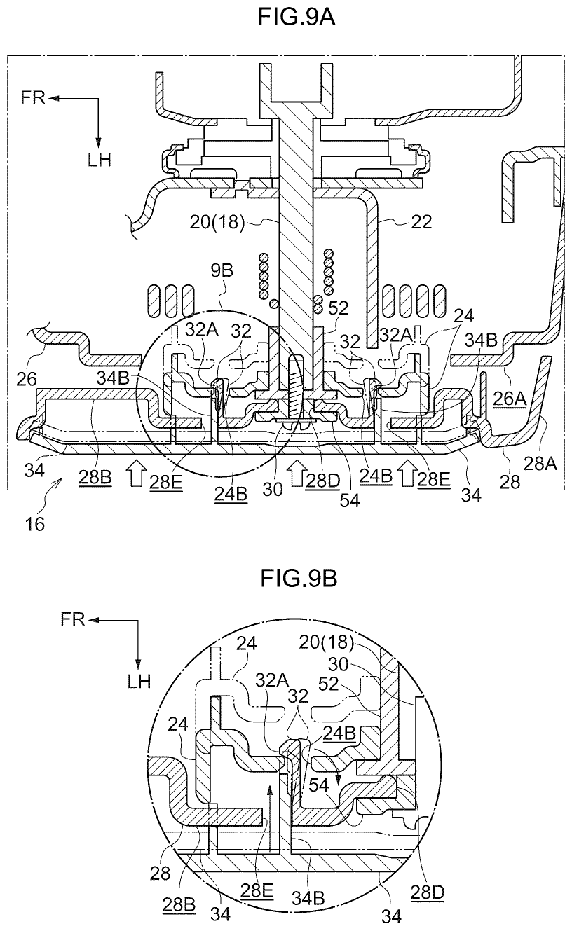

The insertion hole 28E is formed to penetrate through the bottom wall of the coupling recess 28B on the upper side and the lower side of the front side of the screw 30 and the upper side and the lower side of the rear side thereof, and the connecting claw 32 (see FIGS. 9A and 9B) having a substantially rectangular plate shape is integrally provided at the end portion of the insertion hole 28E on the screw 30 side. The connecting claw 32 extends to the right side, the connecting protrusion 32A of the distal end portion (right end portion) of the connecting claw 32 protrudes to a side opposite to the screw 30, and the left surface is inclined in a direction toward the side opposite to the screw 30 as it goes rightward. The connecting claw 32 is inserted into the connecting hole 24B of the catch plate 24 by temporary elastic deformation, and the left surface of the connecting protrusion 32A is engaged with the outer end (the end opposite to the screw 30) of the connecting hole 24B from the right side, whereby the rightward movement of the catch plate 24 is restricted. A connecting projection 28F (see FIG. 10) having a substantially rectangular plate shape as a connecting portion is integrally provided on the right surface of the bottom wall of the coupling recess 28B on the front side and the rear side of the screw 30, and the connecting projection 28F protrudes rightward. The connecting projection 28F is fitted into the connecting notch 24C of the catch plate 24, and the connecting projection 28F restricts relative rotation of the catch plate 24. Thereby, the knob 28 is integrally rotatably connected to the catch plate 24.

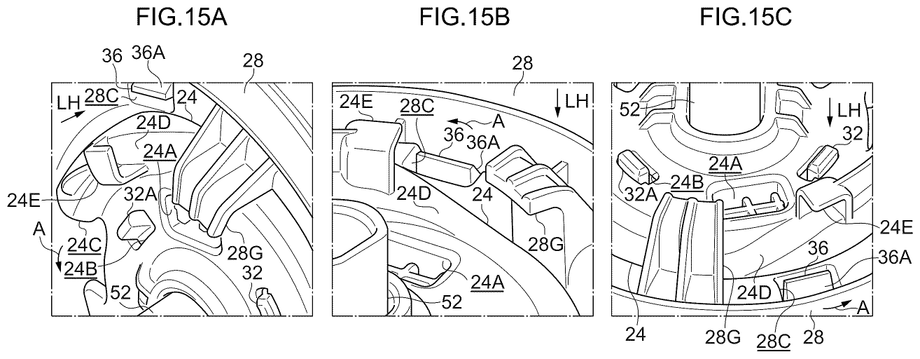

A moving hook 28G (see FIGS. 15A, 15B, and 15C) having an L-shaped cross section plate shape as a moving portion is integrally provided on the right surface of the bottom wall of the coupling recess 28B on the upper side and the lower side of the screw 30, the moving hook 28G protrudes to the right side, and a distal end portion (right end portion) protrudes to the screw 30 side. The distal end portion of the moving hook 28G is disposed on a side opposite to the release direction A of the inclined surface 24D of the catch plate 24, and the distal end portion of the moving hook 28G is separated to the right side from the catch plate 24.

A rib 34B (see FIGS. 9A and 9B) having a rectangular plate shape as a release portion is integrally provided on the right surface of the cap 34 on the left side of each insertion hole 28E of the knob 28, and the rib 34B protrudes rightward. The rib 34B is inserted into the insertion hole 28E, and the rib 34B is opposed to the connecting projection 28F of the connecting claw 32 of the knob 28 in the right-left direction.

Next, the operation of this embodiment will be described.

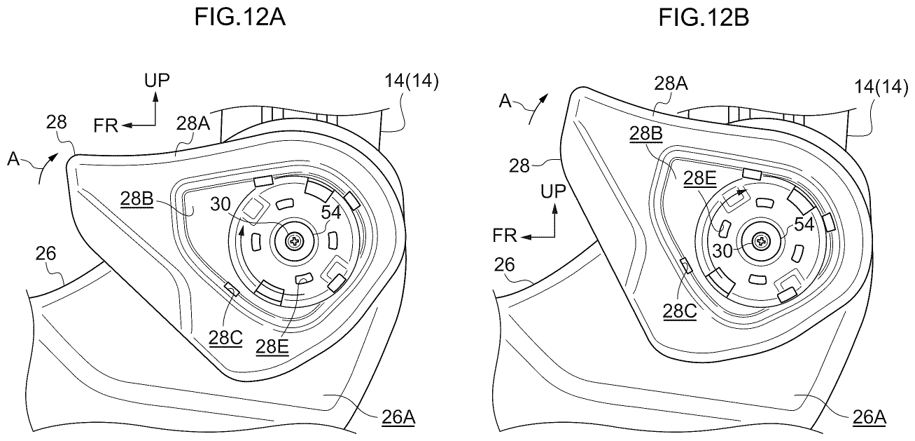

In the reclining device 16 of the vehicle seat 50 having the above configuration, the lock mechanism 18 locks the tilting of the seat back 14, and the catch plate 24 is integrally rotatably connected to the shaft 20 of the lock mechanism 18. The left surface of the connecting protrusion 32A of the connecting claw 32 of the knob 28 is engaged with the outer end of the connecting hole 24B of the catch plate 24, the connecting projection 28F of the knob 28 is fitted into the connecting notch 24C of the catch plate 24, and the knob 28 is integrally rotatably connected to the catch plate 24. In a case in which the knob 28 (including the cap 34) is operated to rotate by a predetermined angle in the release direction A (see FIG. 12A), the catch plate 24 and the shaft 20 (including the bush 52) are rotated by a predetermined angle in the release direction A integrally with the knob 28, and the lock mechanism 18 unlocks the tilting of the seat back 14.

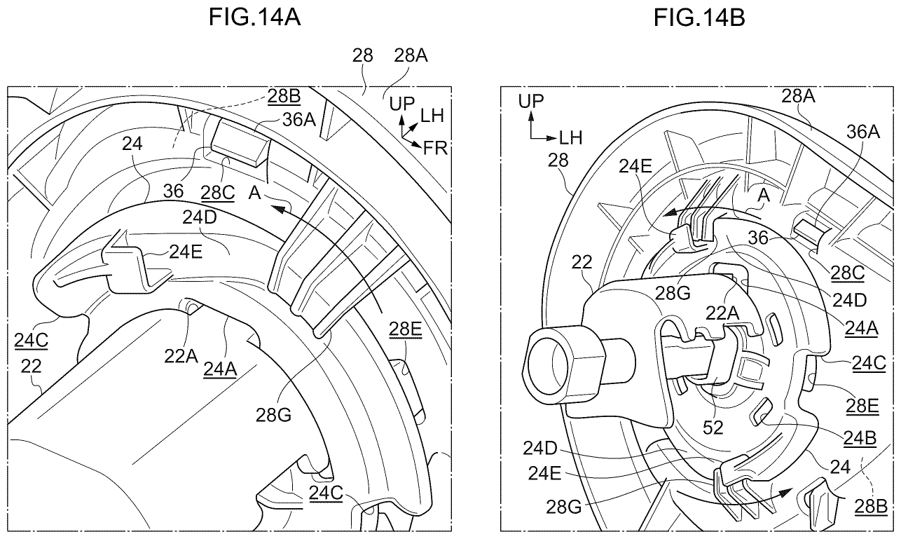

In a case in which an impact load from the B-pillar of the vehicle is input to the cap 34 at the time of side collision of the vehicle and the cap 34 is moved rightward (inward in the vehicle width direction), the cap 34 presses the catch plate 24 rightward via the knob 28, so that the catch plate 24 is moved rightward (see FIGS. 9A and 9B). In a case in which the outer end of the connecting hole 24B presses the left surface of the connecting protrusion 32A and the connecting claw 32 is moved to the screw 30 side, the connecting claw 32 (connecting protrusion 32A) is disengaged from the connecting hole 24B, and the connecting notch 24C is detached from the connecting projection 28F, so that the knob 28 is disconnected from the catch plate 24. The catch plate 24 abuts on the distal end portion of the moving hook 28G of the knob 28, and the restricting plate 22A of the bracket 22 is inserted into the restriction hole 24A of the catch plate 24, so that the bracket 22 regulates the rotation of the catch plate 24 (see FIGS. 13B and 14A).

Thereby, even in a case in which the knob 28 is operated to rotate by an impact load, the rotation of the catch plate 24 can be restricted, so that the unlocking of the tilting of the seat back 14 can be restricted and the unnecessary tilting of the seat back 14 can be restricted.

In a case in which the cap 34 is moved to the right side by an impact load at the time of side collision of the vehicle, the rib 34B of the cap 34 moves the connecting protrusion 32A of the connecting claw 32 toward the screw 30 to assist the disengagement of the connecting claw 32 (connecting protrusion 32A) from the connecting hole 24B. Therefore, the connecting claw 32 can be appropriately disengaged from the connecting hole 24B, and the knob 28 can be appropriately disconnected from the catch plate 24.

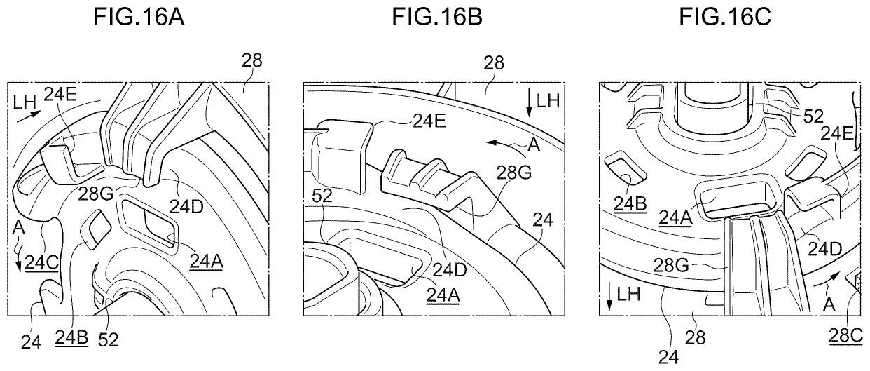

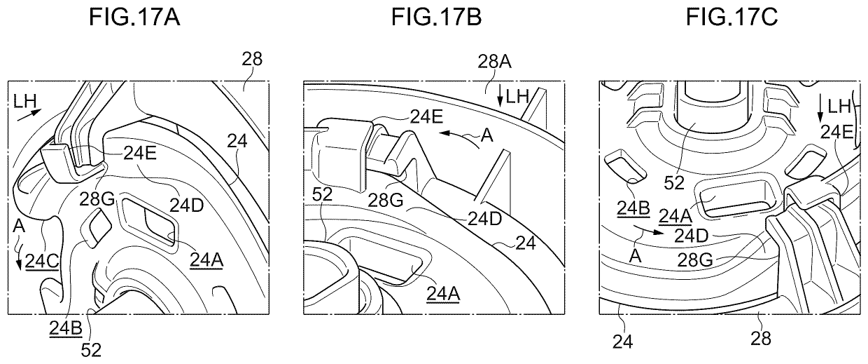

After the side collision of the vehicle (after the knob 28 is disconnected from the catch plate 24), the knob 28 is operated to rotate by a predetermined angle in the release direction A (see FIG. 12A), so that the distal end portion of the moving hook 28G moves the inclined surface 24D of the catch plate 24 to the left side, and the catch plate 24 is moved to the left side (see FIGS. 16A, 16B, and 16C). Therefore, the restricting plate 22A of the bracket 22 is disengaged from the restriction hole 24A of the catch plate 24, and the distal end portion of the moving hook 28G abuts on the proximal end side portion of the rotation hook 24E of the catch plate 24 (see FIGS. 14B, 17A, 17B, and 17C), so that the bracket 22 releases the restriction on the rotation of the catch plate 24, and the knob 28 is integrally rotatably connected to the catch plate 24. Thereby, in a case in which the knob 28 is further operated to rotate by a predetermined angle in the release direction A (see FIG. 12B), the catch plate 24 and the shaft 20 (including the bush 52) can be rotated integrally with the knob 28 by a predetermined angle in the release direction A, the tilting of the seat back 14 can be unlocked, the seat back 14 can be tilted, and the occupant can escape to the outside of the vehicle, for example.

As described above, after the side collision of the vehicle, the knob 28 is operated to rotate so as to move the catch plate 24, so that the knob 28 is connected to the catch plate 24 and the bracket 22 releases the restriction on the rotation of the catch plate 24. Therefore, with a simple configuration, the knob 28 can be connected to the catch plate 24, and the bracket 22 can release the restriction on the rotation of the catch plate 24.

The rotational operation amount (predetermined angle) of the knob 28 for causing the knob 28 to be connected to the catch plate 24 after the side collision of the vehicle and for causing the bracket 22 to release the restriction on the rotation of the catch plate 24 is the same as the rotational operation amount (predetermined angle) of the knob 28 for causing the lock mechanism 18 to unlock the tilting of the seat back 14 in the normal state of the vehicle (before the side collision). Therefore, after the side collision of the vehicle, the knob 28 is unnecessarily connected to the catch plate 24 and the bracket 22 releases the restriction on the rotation of the catch plate 24, so that it is possible to suppress the unlocking of the tilting of the seat back 14.

In this embodiment, the operation amount of the knob 28 for causing the knob 28 to be connected to the catch plate 24 after the side collision of the vehicle and for causing the bracket 22 to release the restriction on the rotation of the catch plate 24 is the same as the operation amount of the knob 28 for causing the lock mechanism 18 to unlock the tilting of the seat back 14 in the normal state of the vehicle. However, the operation amount of the knob 28 for causing the knob 28 to be connected to the catch plate 24 after the side collision of the vehicle and for causing the bracket 22 to release the restriction on the rotation of the catch plate 24 may be made larger than the operation amount of the knob 28 for causing the lock mechanism 18 to unlock the tilting of the seat back 14 in the normal state of the vehicle.

What is claimed is:

1. A reclining device comprising:
a lock mechanism locking tilting of a seat back in a vehicle seat;
a connecting member connected to the lock mechanism, the connecting member being rotated so that the lock mechanism unlocks tilting of the seat back;
an operation member connected to the connecting member, the operation member being operated to rotate the connecting member and being disconnected from the connecting member by receiving an impact load at a time of a side collision of a vehicle; and
a restriction member restricting rotation of the connecting member in a case in which the operation member is disconnected from the connecting member.

2. The reclining device according to claim 1, wherein, after the operation member is disconnected from the connecting member and the restriction member restricts rotation of the connecting member, the operation member is operated so that the operation member is connected to the connecting member and the restriction member releases the restriction on the rotation of the connecting member.

3. The reclining device according to claim 2, wherein, after the operation member is disconnected from the connecting member and the restriction member restricts rotation of the connecting member, the operation member is operated to move the connecting member, so that the operation member is connected to the connecting member and the restriction member releases the restriction on the rotation of the connecting member.

4. The reclining device according to claim 2, wherein an operation amount of the operation member for causing the operation member to be connected to the connecting member and for causing the restriction member to release the restriction on the rotation of the connecting member is equal to or larger than an operation amount of the operation member for causing the lock mechanism to unlock tilting of the seat back.

5. The reclining device according to claim 1, wherein, in a case in which an impact load is input to the operation member at the time of a side collision of the vehicle and the operation member is moved, the operation member is disconnected from the connecting member.

6. The reclining device according to claim 1, wherein, in a case in which an impact load is input to the operation member at the time of a side collision of the vehicle and the operation member moves the connecting member, the restriction member restricts rotation of the connecting member.

7. The reclining device according to claim 1, wherein the operation member comprises:
a body member connected to the connecting member; and
a covering member disconnecting the body member from the connecting member and causing the restriction member to restrict the rotation of the connecting member by receiving an impact load at the time of a side collision of the vehicle.

8. A vehicle seat comprising:
a seat cushion;
a seat back; and
the reclining device according to claim 1 provided between the seat cushion and the seat back.
